(19) United States
(12) Patent Application Publication
(10) Pub. No.: US 2019/0173123 A1
(43) Pub. Date: Jun. 6, 2019

(54) LITHIUM ION SECONDARY BATTERY

(71) Applicant: NEC CORPORATION, Tokyo (JP)

(72) Inventors: Ikiko SHIMANUKI, Tokyo (JP); Daisuke KAWASAKI, Tokyo (JP); Hitoshi ISHIKAWA, Tokyo (JP); Suguru TAMAI, Tokyo (JP)

(73) Assignee: NEC CORPORATION, Tokyo (JP)

(21) Appl. No.: 16/095,850

(22) PCT Filed: May 23, 2017
(86) PCT No.: PCT/JP2017/019184

§ 371 Date: Oct. 23, 2018

(30) Foreign Application Priority Data
May 26, 2016 (JP) 2016-105374

(51) Int. Cl. H01M 10/0525; H01M 4/38; H01M 10/0567; B60L 50/64

(52) U.S. Cl. CPC H01M 10/0525; H01M 4/386; H01M 2004/027; B60L 50/64; H01M 10/0567

(57) ABSTRACT

A lithium ion secondary battery having high energy density and excellent cycle characteristics is provided. The present invention relates to a lithium ion secondary battery comprising a negative electrode comprising a negative electrode active material comprising more than 25% by weight of a silicon alloy and a non-aqueous electrolyte solution comprising more than 10% by weight of a compound represented by LiN(SO₂CₙF₂ₙ₊₁)₂ (wherein n is an integer of 0 or more) and 10% by weight or more of fluoroethylene carbonate (FEC).

### TECHNICAL FIELD

The present invention relates to a lithium ion secondary battery.

### BACKGROUND ART

Lithium ion secondary batteries have advantages such as high energy density, low self-discharge, excellent long-term reliability and the like, and therefore they have been put into practical use in notebook-type personal computers, mobile phones and the like. Furthermore, in recent years, in addition to high functionality of electronic devices, by expansion of the market for motor-driven vehicles such as electric vehicles and hybrid vehicles, and acceleration of development of home and industrial power storage systems, development of a high performance lithium ion secondary battery which is excellent in battery characteristics such as cycle characteristics and storage characteristics and further improved in capacity and energy density is demanded.

As a negative electrode active material providing a high capacity lithium ion secondary battery, metal-based active materials such as silicon, tin, alloys thereof, and metal oxides comprising these have attracted attention. However, while these metal-based negative electrode active materials give high capacity, the expansion and shrinkage of the active material during absorbing and desorbing lithium ions is large. By the volume change of expansion and shrinkage, when charge and discharge are repeated, the negative electrode active material particles collapse and a new active surface is exposed. There is a problem that this active surface decomposes the electrolyte solution solvent and reduces cycle characteristics of the battery. Various studies have been conducted to improve the battery characteristics of lithium ion secondary batteries having high capacity. For example, Patent Document 1 describes a non-aqueous electrolyte battery comprising a negative electrode comprising a negative electrode active material containing metallic particles capable of forming an alloy with Li and graphite particles, and a compound having a fluorosulfonyl structure.

In order to obtain a lithium ion secondary battery having excellent cycle characteristics, many studies have been made on the composition of the electrolyte solution. For example, Patent Document 2 describes a lithium secondary battery comprising a lithium sulfonylimide salt represented by a predetermined formula. Patent Document 3 describes a non-aqueous electrolyte secondary battery comprising a lactone and lithium bisfluorosulfonylimide.

### CITATION LIST

### Patent Document

Patent Document 1: WO2014/157691

Patent Document 2: Japanese Patent Laid-Open Publication No. 2014-029840

Patent Document 3: Japanese Patent Laid-Open Publication No. 2004-165151

### SUMMARY OF INVENTION

### Technical Problem

However, in the negative electrode of the secondary battery described in Patent Document 1, the content of metal particles capable of forming an alloy with Li is 25% by mass or less in the negative electrode active material, and thus it is difficult to improve the energy density of the secondary battery (electric energy per unit weight) by 20% or more as compared with the case where the negative electrode active material is composed of only graphite. In Patent Documents 2 and 3, lithium ion secondary batteries having a negative electrode containing a silicon alloy have not been studied in detail.

Accordingly, an object of the present invention is to provide a lithium ion secondary battery having high energy density and excellent cycle characteristics.

### Solution to Problem

One embodiment of the present invention relates to the following items.

A lithium ion secondary battery comprising:

a negative electrode comprising a negative electrode active material comprising a silicon alloy and

a non-aqueous electrolyte solution comprising a compound represented by LiN(SO₂CₙF₂ₙ₊₁)₂ (wherein n is an integer of 0 or more) and fluoroethylene carbonate (FEC), wherein

a content of the silicon alloy in the negative electrode active material is more than 25% by weight, and

a content of the compound represented by LiN(SO₂CₙF₂ₙ₊₁)₂ (wherein n is an integer of 0 or more) is more than 10% by weight, a content of FEC is 10% by weight or more, and a content of LiPF₆ is 10% by weight or less, in the non-aqueous electrolyte solution.

### Advantageous Effect of Invention

According to the present invention, a lithium ion secondary battery having high energy density and excellent cycle characteristics can be provided.

### BRIEF DESCRIPTION OF DRAWING

FIG. 1 is a sectional view of a lithium ion secondary battery according to one embodiment of the present invention.

FIG. 2 is a schematic sectional view showing a structure of a stacking laminate type of a secondary battery according to one embodiment of the present invention.

FIG. 3 is an exploded perspective view showing a basic structure of a film-packaged battery.

FIG. 4 is a cross-sectional view schematically showing a cross-section of the battery in FIG. 3.

### DESCRIPTION OF EMBODIMENTS

A lithium ion secondary battery according to one embodiment of the present invention comprises a negative electrode comprising a negative electrode active material comprising a silicon alloy and a non-aqueous electrolyte solution comprising a compound represented by LiN(SO₂CₙF₂ₙ₊₁)₂ (wherein n is an integer of 0 or more) and fluoroethylene carbonate (FEC), wherein a content of the silicon alloy in the negative electrode active material is more than 25% by weight, and a content of the compound represented by LiN(SO₂CₙF₂ₙ₊₁)₂ (wherein n is an integer of 0 or more) is more than 10% by weight, a content of FEC is 10% by weight or more, and a content of LiPF₆ is 10% by weight or less, in the non-aqueous electrolyte solution. Hereinafter, details of the lithium ion secondary battery (also simply referred to as “secondary battery”) of the present embodiment will be described for each constituting member. In this specification, “cycle characteristics” means characteristics such as a capacity retention ratio after repeating charge and discharge.

### [Negative Electrode]

The negative electrode may have a structure in which a negative electrode active material layer comprising a negative electrode active material is formed on a current collector. The negative electrode of the present embodiment has, for example, a negative electrode current collector formed of a metal foil and a negative electrode active material layer formed on one surface or both surfaces of the negative electrode current collector. The negative electrode active material layer is formed so as to cover the negative electrode current collector with a negative electrode binder. The negative electrode current collector is arranged to have an extended portion connected to a negative electrode terminal, and the negative electrode active material layer is not formed on this extended portion. The negative electrode active material is a material capable of absorbing and desorbing lithium. In the present specification, materials that do not intrinsically absorb and desorb lithium, such as most of binders, are not included in the negative electrode active material.

### (Negative Electrode Active Material)

In the present embodiment, the negative electrode active material comprises a silicon alloy. The silicon alloy is an alloy of silicon and a metal other than silicon (non-silicon metal), and for example, an alloy of silicon and at least one selected from the group consisting of Li, B, Al, Ti, Fe, Pb, Sn, In, Bi, Ag, Ba, Ca, Hg, Pd, Pt, Te, Zn, and La is preferable, and an alloy of silicon and at least one selected from the group consisting of Li, B, Ti and Fe is more preferable. The content of non-silicon metal(s) in the alloy of silicon and non-silicon metal(s) is not particularly limited, but for example, 0.1-5 wt % is preferable. Examples of a method of manufacturing an alloy of silicon and non-silicon metal(s) include a method of mixing and melting elemental silicon and non-silicon metal(s) and a method of coating the surface of elemental silicon with non-silicon metal(s) by vapor deposition or the like.

The silicon alloy contained in the negative electrode active material may be one kind or two or more kinds.

These silicon alloys may be used in powder form. In this case, a 50% particle diameter (median diameter) D50 of the silicon alloy powder is preferably 2.0 μm or less, more preferably 1.0 μm or less, further preferably 0.5 μm or less. By reducing the particle size, the effect of improving the cycle characteristics according to the present invention can be increased. The 50% particle diameter (median diameter) D50 of the particles of the silicon alloy is preferably 1 nm or more. The specific surface area (CS) of the silicon alloy powder is preferably 1 m²/cm³ or more, more preferably 5 m²/cm³ or more, further preferably 10 m²/cm³ or more. The specific surface area (CS) of the silicon metal powder is preferably 3000 m²/cm³ or less. Herein, CS (Calculated Specific Surfaces Area) means a specific surface area (unit: m²/cm³) assuming that particles are spheres.

The silicon alloy powder (for example, a powder having a median diameter of 2.0 μm or less) may be prepared by a chemical synthesis method or may be obtained by pulverizing a coarse silicon compound (for example, silicon having a size of about 10 μm to 100 μm). The pulverization can be carried out by a conventional method, for example, using a conventional pulverizing machine such as a ball mill and a hammer mill or pulverizing means.

A part of or all of the surface of the silicon alloy may be coated with silicon oxide. The coating amount of silicon oxide is desirably 5% by weight or less based on the weight of the Si alloy.

The content of the silicon alloy in the negative electrode active material is preferably more than 25% by weight, more preferably 25.5% by weight or more, further preferably 30% by weight or more, particularly preferably 33% by weight or more, and the upper limit is preferably less than 100 wt %, more preferably 80 wt % or less, further preferably 60 wt % or less, particularly preferably 50 wt % or less. When the content of the silicon alloy is within the above content range, the energy density of the lithium ion secondary battery can be improved and also the cycle characteristics thereof can be improved.

In addition to the silicon alloy, the negative electrode active material preferably comprises other negative electrode active materials. Examples of other negative electrode active materials include a silicon material other than a silicon alloy, carbon and the like.

The silicon material other than a silicon alloy (also referred to as “other silicon material”) is a material containing silicon as a constituent element, and examples thereof include elemental silicon and silicon oxide represented by the composition formula SiOx (0<x≤2) and the like. The content of the other silicon material may be 0% by weight, preferably 0.1% by weight or more and 50% by weight or less in the negative electrode active material.

In addition to the silicon alloy, the negative electrode active material preferably comprises carbon. By using the silicon alloy with carbon, it is possible to reduce the influence of expansion and shrinkage of silicon when lithium ions are absorbed and desorbed, and thereby improving cycle characteristics of the battery. A silicon alloy and carbon may be mixed and used, but a particle of a silicon alloy whose surface is coated with carbon may be used. Examples of the carbon include graphite, amorphous carbon, graphene, diamond-like carbon, carbon nanotube, or a composite thereof. Graphite having high crystallinity has high electrical conductivity and is excellent in adhesion to a negative electrode current collector made of a metal such as copper, and excellent in flatness of voltage. On the other hand, since amorphous carbon having low crystallinity is relatively small in volume expansion, the effect of reducing of the entire negative electrode is high, and deterioration due to non-uniformity such as crystal grain boundaries and defects may hardly occurs. The content of the carbon material in the negative electrode active material is preferably less than 75 wt %, more preferably 30 wt % or more and less than 75 wt %.

As another negative electrode active material which may be used in combination with the silicon alloy, metals other than silicon and metal oxides may also be exemplified. Examples of the metal include Li, Al, Ti, Pb, Sn, In, Bi, Ag, Ba, Ca, Hg, Pd, Pt, Te, Zn, La and an alloy of two or more thereof. In addition, these metals or alloys may comprise one or two or more non-metallic elements. Examples of the metal oxide may include aluminum oxide, tin oxide, indium oxide, zinc oxide, lithium oxide, or a composite thereof. In addition, one or two or more elements selected from nitrogen, boron and sulfur may be added to the metal oxide, in an amount of, for example, 0.1 to 5% by mass. This makes it possible to improve the electric conductivity of the metal oxide.

The negative electrode active material may comprise one kind alone or two or more kinds.

### (Negative Electrode Binder)

The negative electrode binder is not particularly limited, but examples thereof include polyacrylic acid, styrene butadiene rubber (SBR), polyvinylidene fluoride, vinylidene fluoride-hexafluoropropylene copolymer, vinylidene fluoride-tetrafluoroethylene copolymer, polytetrafluoroethylene, polypropylene, polyethylene, polyimide, polyamideimide and the like may be used. In addition, thickeners such as carboxymethyl cellulose (CMC) may be used in combination. Among these, from the viewpoint of excellent binding property, it is preferable to comprise at least one selected from the group consisting of a combination of SBR and CMC, polyacrylic acid and polyimide, and more preferable to comprise polyacrylic acid.

The content of the negative electrode binder is not particularly limited, but from the viewpoint of “sufficient binding property” and “high energy production” being in a trade-off relation with each other, it is preferably 0.1% by mass or more, more preferably 0.5% by mass or more, further preferably 1% by mass or more, and the upper limit is preferably 20% by mass or less, more preferably 15% by mass or less, based on 100% by mass of the total mass of the negative electrode active material.

Hereinafter, as one aspect of the present embodiment, polyacrylic acid as a negative electrode binder will be described in detail, but the present invention is not limited thereto.

Polyacrylic acid as a negative electrode binder comprises a monomer unit based on an ethylenically unsaturated carboxylic acid. Examples of the ethylenically unsaturated carboxylic acid include acrylic acid, methacrylic acid, crotonic acid, maleic acid, fumaric acid and itaconic acid, and one type or two or more types may be used. The content of the monomer unit based on the ethylenically unsaturated carboxylic acid in the polyacrylic acid is preferably 50% by mass or more.

In the polyacrylic acid, all or a part of the carboxylic acid groups contained in the monomer units based on the ethylenically unsaturated carboxylic acid may be carboxylic acid salt group(s), which can improve the binding strength in some cases. Examples of the carboxylic acid salt include an alkali metal salts. Examples of the alkali metal constituting the salt include lithium, sodium and potassium, and sodium and potassium are particularly preferable. When the polyacrylic acid comprises a monomer unit based on an alkali metal salt of an ethylenically unsaturated carboxylic acid, the amount of the alkali metal contained in the polyacrylic acid is preferably 5,000 ppm by mass or more in the polyacrylic acid, and the upper limit is not particularly limited, but for example, 100,000 ppm by mass or less is preferable. As alkali metals constituting the carboxylic acid salts, plural kinds of alkali metals may be contained. In one aspect of the present embodiment, it is preferred that sodium is present in the polyacrylic acid in an amount of 5000 ppm by mass or more of the polyacrylic acid and/or potassium is present in the polyacrylic acid in an amount of 1 ppm by mass or more and 5 ppm by mass or less of the polyacrylic acid. When the electrode is prepared, the presence of the monomer unit based on the alkali metal salt of ethylenically unsaturated carboxylic acid in the polyacrylic acid can improve the binding property between the active materials and also improve peeling strength between the electrode material mixture layer and the current collector. Thus, it is presumed that it is possible to suppress destruction or the like of the binding structure between the active material particles which is caused by expansion and shrinkage of the active materials, and thus the cycle characteristics of the battery can be improved.

The polyacrylic acid is preferably a copolymer. In one aspect of the present embodiment, it is preferred that the polyacrylic acid comprises a monomer unit based on an ethylenically unsaturated carboxylic acid ester and/or a monomer unit based on an aromatic vinyl compound in addition to the monomer unit based on an ethylenically unsaturated carboxylic acid. When the polyacrylic acid comprises these monomer units, the peeling strength between the electrode material mixture layer and the current collector can be improved, and therefore, the cycle characteristics of the battery can be improved.

Examples of the ethylenically unsaturated carboxylic acid ester include acrylic acid ester, methacrylic acid ester, crotonic acid ester, maleic acid ester, fumaric acid ester and itaconic acid ester. Particularly alkyl esters are preferable. The content of the monomer unit based on the ethylenically unsaturated carboxylic acid ester in the polyacrylic acid is preferably 10% by mass or more and 20% by mass or less.

Examples of the aromatic vinyl compound include styrene, α-methylstyrene, vinyltoluene and divinylbenzene, and one kind or two or more kinds may be used. The content of the monomer unit based on the aromatic vinyl compound in the polyacrylic acid is preferably 5% by mass or less.

The polyacrylic acid may comprise other monomer units. Examples of other monomer units include monomer units based on the compounds such as acrylonitrile and conjugated dienes.

The molecular weight of the polyacrylic acid is not particularly limited, but the weight-average molecular weight is preferably 1000 or more, more preferably in the range of 10,000 to 5,000,000, and particularly preferably in the range of 300,000 to 350,000. When the weight-average molecular weight is within the above range, good dispersibility of the active material and the conductive assistant agent can be maintained and excessive increase in slurry viscosity can be suppressed.

In one aspect of the present embodiment, the content of polyacrylic acid relative to the total amount of the negative electrode binder is preferably 50% by weight or more, more preferably 70% by weight or more, and further preferably 80% by weight or more, and it may be 100% by weight. In general, an active material having a large specific surface area requires a large amount of a binder, but the polyacrylic acid has high binding ability even in a small amount. Therefore, when the polyacrylic acid is used as the negative electrode binder, the increase in resistance due to the binder is small even for the electrode comprising an active material having a large specific surface area. In addition, the binder comprising the polyacrylic acid is excellent in reducing the irreversible capacity of the battery, increasing the capacity of the battery and improving the cycle characteristics.

For the purpose of lowering the impedance, the negative electrode may additionally comprise a conductive assistant agent. Examples of the additional conductive assistant agent include flake-like or fibrous carbonaceous fine particles, for example, carbon black, acetylene black, Ketjen black, vapor grown carbon fiber, and the like.

As the negative electrode collector, in view of electrochemical stability, aluminum (preferably in the case of using a negative electrode active material having a high negative electrode potential), nickel, copper, silver and alloys thereof are preferable. The shape thereof may be in the form of foil, flat-plate or mesh.

The negative electrode may be produced according to a usual method. In one embodiment, first, a silicon alloy as a negative electrode active material, a negative electrode binder, and as an optional component, a conductive assistant agent and an other negative electrode active material other than the silicon alloy are mixed in a solvent, preferably mixed with a V type mixer (V blender), mechanical milling or the like in a stepwise manner to prepare a slurry. Subsequently, the prepared slurry is applied to a negative electrode current collector and dried to prepare a negative electrode. Applying may be carried out by a doctor blade method, a die coater method, a CVD method, a sputtering method or the like.

[Positive Electrode]

The positive electrode may have a structure in which a positive electrode active material layer comprising a positive electrode active material is formed on a current collector. The positive electrode of the present embodiment has, for example, a positive electrode current collector formed of a metal foil and a positive electrode active material layer formed on one surface or both surfaces of the positive electrode current collector. The positive electrode active material layer is formed so as to cover the positive electrode current collector by the positive electrode binder. The positive electrode current collector is arranged to have an extended portion connected to a positive electrode terminal, and the positive electrode active material layer is not formed on this extended portion.

The positive electrode active material is not particularly limited as long as it is a material capable of absorbing and desorbing lithium, and it may be selected from some view points. From the viewpoint of high energy density, a compound having high capacity is preferably contained. Examples of the high capacity compound include lithium nickelate (LiNiO₂), or lithium nickel composite oxides in which a part of the Ni of lithium nickelate is replaced by another metal element, and layered lithium nickel composite oxides represented by the following formula (A) are preferred.

Li_{y}Ni₍₁₋ₓ₎MₓO₂ (A)

wherein 0≤x<1, 0<y≤1, and M is at least one element selected from the group consisting of Li, Co, Al, Mn, Fe, Ti, and B.

From the viewpoint of high capacity, it is preferred that the content of Ni is high, that is, x is less than 0.5, further preferably 0.4 or less in the formula (A). Examples of such compounds include Li_{α}Ni_{β}Co_{γ}Mn_{δ}O₂ (0<α≤1.2, preferably 1≤α≤1.2, α+β+γ+δ≤2, β≥0.7, and γ≤0.2) and Li_{α}Ni_{β}Co_{γ}Al_{δ}O₂ (0<α≤1.2, preferably 1≤α≤1.2, α+β+γ+δ≤2, β≥0.6, preferably β≥0.7, and γ≤0.2) and particularly include Li_{α}Ni_{β}Co_{γ}Mn_{δ}O₂ (0.75≤β≤0.85, 0.05≤γ≤0.15, and 0.10≤δ≤0.20). More specifically, for example, LiNi_{0.8}Co_{0.05}Mn_{0.15}O₂, LiNi_{0.8}Co_{0.01}Mn_{0.1}O₂, LiNi_{0.8}Co_{0.15}Al_{0.05}O₂, and LiNi_{0.8}Co_{0.1}Al_{0.1}O₂ may be preferably used.

From the viewpoint of thermal stability, it is also preferred that the content of Ni does not exceed 0.5, that is, x is 0.5 or more in the formula (A). In addition, it is also preferred that particular transition metals do not exceed half. Examples of such compounds include Li_{α}Ni_{β}Co_{γ}Mn_{δ}O₂ (0<α≤1.2, preferably 1≤α≤1.2, α+β+γ+δ≤2, 0.2≤β≤0.5, 0.1≤γ≤0.4, and 0.1≤δ−0.4). More specific examples may include LiNi_{0.4}Co_{0.3}Mn_{0.3}O₂ (abbreviated as NCM433), LiNi_{1/3}Co_{1/8}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532) (also including those in which the content of each transition metal fluctuates by about 10% in these compounds).

In addition, two or more compounds represented by the formula (A) may be mixed and used, and, for example, it is also preferred that NCM532 or NCM523 and NCM433 are mixed in the range of 9:1 to 1:9 (as a typical example, 2:1) and used. Further, by mixing a material in which the content of Ni is high (x is 0.4 or less in the formula (A)) and a material in which the content of Ni does not exceed 0.5 (x is 0.5 or more, for example, NCM433), a battery having high capacity and high thermal stability can also be formed.

Examples of the positive electrode active materials other than the above include lithium manganate having a layered structure or a spinel structure such as LiMnO₂, LiₓMn₂O₄ (0<x<2), Li₂MnO₃, and LiₓMn_{1.5}Ni_{0.5}O₄ (0<x<2); LiCoO₂ or materials in which a part of the transition metal in this material is replaced by other metal(s); materials in which Li is excessive as compared with the stoichiometric composition in these lithium transition metal oxides; materials having olivine structure such as LiMPO₄, and the like. In addition, materials in which a part of elements in these metal oxides is substituted by Al, Fe, P, Ti, Si, Pb, Sn, In, Bi, Ag, Ba, Ca, Hg, Pd, Pt, Te, Zn, La or the like are also usable. The positive electrode active materials described above may be used alone or in combination of two or more.

The positive electrode binder is not particularly limited, but examples thereof include polyvinylidene fluoride, vinylidene fluoride-hexafluoropropylene copolymer, vinylidene fluoride-tetrafluoroethylene copolymer, polytetrafluoroethylene, polypropylene, polyethylene, polyimide, polyamide-imide, polyacrylic acid and the like. Styrene-butadiene rubber (SBR) and the like may be used. When an aqueous binder such as an SBR emulsion is used, a thickener such as carboxymethyl cellulose (CMC) may be used in combination. Two or more kinds of the positive electrode binders may be mixed and used. The amount of the positive electrode binder to be used is preferably 2 to 10 parts by mass based on 100 parts by mass of the positive electrode active material from the viewpoint of “sufficient binding property” and “high energy production” being in a trade-off relation with each other.

To the coating layer comprising the positive electrode active material, an electrical conductive assistant agent may be added for the purpose of reducing the impedance. Examples of the electrical conductive assistant agent include flake-like or fibrous carbonaceous fine particles, such as graphite, carbon black, acetylene black and vapor grown carbon fiber.

As the positive electrode current collector, from the viewpoint of electrochemical stability, aluminum, nickel, copper, silver, and alloys thereof are preferable. The shape thereof may be in the form of foil, flat-plate or mesh. In particular, a current collector using aluminum, an aluminum alloy, or iron-nickel-chromium-molybdenum-based stainless steel are preferable.

The positive electrode may be prepared by forming a positive electrode mixture layer comprising a positive electrode active material and a positive electrode binder on a positive electrode current collector. Examples of a method for forming the positive electrode mixture layer include a doctor blade method, a die coater method, a CVD method, a sputtering method, and the like. After forming the positive electrode mixture layer in advance, a thin film of aluminum, nickel or an alloy thereof may be formed by a method such as vapor deposition, sputtering or the like to obtain a positive electrode current collector.

### [Non-Aqueous Electrolyte Solution]

The non-aqueous electrolyte solution comprises a non-aqueous solvent, a supporting salt and an additive. In the present embodiment, a non-aqueous electrolyte solution comprises a compound represented by LiN(SO₂CₙF₂ₙ₊₁)₂ (wherein n is an integer of 0 or more) as a supporting salt and fluoroethylene carbonate (FEC) as an additive. In the non-aqueous electrolyte solution, it is preferable that a content of the compound represented by LiN(SO₂CₙF₂ₙ₊₁)₂ (wherein n is an integer of 0 or more) is more than 10% by weight, a content of FEC is 10% by weight or more, and a content of LiPF₆ is 10% by weight or less.

### (Non-Aqueous Solvent)

As the non-aqueous solvent, a non-aqueous solvent that is stable at the operating potential of the battery is preferable. Examples of the non-aqueous solvent include aprotic organic solvents including cyclic carbonates such as propylene carbonate (PC), ethylene carbonate (EC), and butylene carbonate (BC); open-chain carbonates such as dimethyl carbonate (DMC), diethyl carbonate (DEC), ethyl methyl carbonate (EMC) and dipropyl carbonate (DPC); propylene carbonate derivatives; aliphatic carboxylic acid esters such as methyl formate, methyl acetate and ethyl propionate; ethers such as diethyl ether and ethyl propyl ether; and fluorinated aprotic organic solvents in which at least a part of the hydrogen atoms of these compounds is(are) substituted with fluorine atom(s).

Among these, cyclic or open-chain carbonates such as ethylene carbonate (EC), propylene carbonate (PC), butylene carbonate (BC), dimethyl carbonate (DMC), diethyl carbonate (DEC), ethyl methyl carbonate (MEC) and dipropyl carbonate (DPC) are preferably comprised.

The non-aqueous solvent may be used alone, or two or more types may be used in combination.

### (Supporting Salt)

The secondary battery of the present embodiment comprises, as a supporting salt, a compound represented by the following formula (I):

LiN(SO₂CₙF₂ₙ₊₁)₂ (wherein n is an integer of 0 or more) (I)

(also simply referred to as “lithium imide salt”). LiPF₆ is widely used as a supporting salt in the non-aqueous electrolyte solution. However, according to detailed investigation by the inventors of the present invention, it was found that when the negative electrode contains a silicon alloy, LiPF₆ and moisture contained in the non-aqueous electrolyte solution are reacted to generate HF (hydrogen fluoride) and the surface of the silicon alloy is corroded, and thus the cycle characteristics of the secondary battery is deteriorated. The inventors of the present invention conducted intensive studies to solve this problem, and found that when a part of or all of LiPF₆ is replaced with a lithium imide salt represented by the above formula (I) and FEC is comprised in predetermined amounts, respectively, in a non-aqueous electrolyte solution, the problem can be solved. Specifically, it was found that, when the content of the lithium imide salt is adjusted to more than 10 wt % and the content of LiPF₆ is adjusted to 10 wt % or less, as a supporting salt in the non-aqueous electrolyte solution, the cycle characteristics of the secondary battery can be improved.

In the above formula (I), n satisfies an integer of 0 or more, and n satisfies preferably 0≤n≤10, more preferably 0≤n≤6, still more preferably 0≤n≤3, and particularly preferably 0 or 1.

Examples of the compound represented by the above formula (I) include lithium bis(fluorosulfonyl)imide (also described as “LiFSI”), lithium bis(trifluoromethanesulfonyl)imide represented by LiN(SO₂CF₃)₂ (also described as “LiTFSI”), lithium bisperfluoroethylsulfonylimide represented by LiN(SO₂C₂F₅)₂ (also referred to as “LiBETI”) and the like, and LiFSI is preferable from the viewpoint of ionic conductivity and high temperature cycle characteristics.

The content of the compound represented by the formula (I) in the non-aqueous electrolyte solution is preferably more than 10% by weight, more preferably 12% by weight or more, and is preferably 25% by weight or less, more preferably 20% by weight or less, further preferably 17% by weight or less. The content of LiPF₆ in the non-aqueous electrolyte solution is preferably 10% by weight or less, more preferably 9% by weight or less, and the lower limit may be 0% by weight, but preferably 0.1% by weight or more, preferably 2% by weight or more, more preferably 5% by weight or more.

In the case where the non-aqueous electrolyte solution comprises both of the lithium imide salt represented by the formula (I) and LiPF₆, regarding the content (weight) of these, the content of the lithium imide salt is preferably 1.1 to 10 times, more preferably 1.2 to 5 times, and still more preferably 1.5 to 3 times the content of LiPF₆. When the weight ratio of the lithium imide salt and LiPF₆ is within the above range, the cycle characteristics of the secondary battery can be improved. The total amount of the lithium imide salt represented by the formula (I) and LiPF₆ in the total weight of supporting salts contained in the non-aqueous electrolyte solution is preferably 80% by weight or more, more preferably 90% by weight or more, and may be 100% by weight.

As the supporting salt in the non-aqueous electrolyte solution, other supporting salts other than the lithium imide salt and LiPF₆ may be comprised. Other supporting salts comprise lithium, and examples thereof include LiAsF₆, LiAlCl₄, LiClO₄, LiBF₄, LiSbF₆, LiCF₃SO₃, LiC₄F₉SO₃, LiC(CF₃SO₂)₃, and the like.

The content of the supporting salt in the non-aqueous electrolyte solution is not particularly limited, but is preferably more than 10% by weight, preferably 12% by weight or more, more preferably 15% by weight or more, and the upper limit is 35% by weight or less, more preferably 30% by weight or less, and still more preferably 25% by weight or less.

### (Additive)

In the present embodiment, the non-aqueous electrolyte solution comprises fluoroethylene carbonate (FEC). The content of FEC in the non-aqueous electrolyte solution is preferably 10% by weight or more, and the upper limit thereof is not particularly limited, but it is preferably 20% by weight or less, more preferably 15% by weight or less. When the non-aqueous electrolyte solution comprises FEC in an amount within the above range, it is possible to prevent Si alloy from reacting with the electrolyte solution and becoming passive state, and thereby the cycle characteristics of the secondary battery can be improved. In this specification, FEC is also referred to as “first additive”.

The electrolyte solution may further comprise additives other than FEC (also described as “second additive”). The second additive is not particularly limited, but examples thereof include unsaturated carboxylic acid anhydride, fluorinated carboxylic acid anhydride, unsaturated cyclic carbonate, cyclic or open-chain disulfonic acid ester, and the like. By adding these compounds, the cycle characteristics of the battery can be further improved. This is presumably because these additives decompose during charge and discharge of the secondary battery to form a film on the surface of the electrode active material and suppress decomposition of the electrolyte solution and the supporting salt.

The unsaturated carboxylic acid anhydride is a carboxylic acid anhydride having at least one carbon-carbon unsaturated bond in the molecule. Cyclic unsaturated carboxylic acid anhydrides are particularly preferred. Examples of the unsaturated carboxylic acid anhydride include maleic anhydride and derivatives thereof such as maleic anhydride, methyl maleic anhydride, ethyl maleic anhydride, 3,4-dimethyl maleic anhydride and 3,4-diethyl maleic anhydride; and succinic acid derivatives such as itaconic anhydride, vinyl succinic anhydride and the like.

The content of the unsaturated carboxylic acid anhydride in the electrolyte solution is not particularly limited, but it is preferably 0.01% by mass or more to 10% by mass or less. When the content is 0.01% by mass or more, a sufficient film forming effect can be obtained. When the content is 10% by mass or less, gas generation due to decomposition of the unsaturated carboxylic acid anhydride itself can be suppressed.

The fluorinated carboxylic acid anhydride is a carboxylic acid anhydride containing at least one fluorine atom in the molecule. Examples of the fluorinated carboxylic acid anhydride include fluoroaliphatic carboxylic acid anhydride such as monofluoroacetic anhydride, trifluoroacetic anhydride, pentafluoropropionic anhydride, trifluoropropionic anhydride, heptafluorobutyric anhydride; fluoroaromatic carboxylic acid anhydride such as monofluorobenzoic anhydride, difluorobenzoic anhydride, fluoromethylbenzoic anhydride, and (trifluoromethyl)benzoic anhydride; fluoroaliphatic or fluoroaromatic dicarboxylic acid anhydride such as tetrafluorosuccinic anhydride, difluoromaleic anhydride, fluorophthalic anhydride, hexafluoroglutaric anhydride. The content of the fluorinated carboxylic acid anhydride in the electrolyte solution is preferably from 0.01% by mass or more and 10% by mass or less. When it is comprised in an amount of 0.01% by mass or more, a sufficient film forming effect can be obtained. When the content is 10 mass % or less, gas generation due to decomposition of the fluorinated carboxylic acid anhydride itself can be suppressed.

The unsaturated cyclic carbonate is a cyclic carbonate having at least one carbon-carbon unsaturated bond in the molecule. Examples of the unsaturated cyclic carbonate include vinylene carbonate compounds such as vinylene carbonate, methyl vinylene carbonate, ethyl vinylene carbonate, 4,5-dimethyl vinylene carbonate, 4,5-diethyl vinylene carbonate and the like; vinyl ethylene carbonate compounds such as 4-vinyl ethylene carbonate, 4-methyl-4-vinyl ethylene carbonate, 4-ethyl-4-vinyl ethylene carbonate, 4-n-propyl-4-vinylene ethylene carbonate, 5-methyl-4-vinylethylene carbonate, 4,4-divinyl ethylene carbonate, 4,5-divinyl ethylene carbonate, 4,4-dimethyl-5-methylene ethylene carbonate and 4,4-diethyl-5-methylene ethylene carbonate.

The content of the unsaturated cyclic carbonate in the electrolyte solution is not particularly limited, but it is preferably 0.01% by mass or more and 10% by mass or less. When the content is 0.01% by mass or more, a sufficient film forming effect can be obtained. When the content is 10% by mass or less, gas generation due to decomposition of the unsaturated cyclic carbonate itself can be suppressed.

As the cyclic or open-chain disulfonic acid esters, for example, cyclic disulfonic acid esters represented by the following formula (C) or open-chain disulfonic acid esters represented by the following formula (D) can be exemplified.

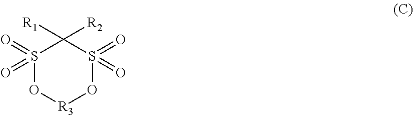

In formula (C), R₁ and R₂, each independently represent a substituent selected from the group consisting of a hydrogen atom, an alkyl group having 1 to 5 carbon atoms, a halogen group, and an amino group. R₃ represents an alkylene group having 1 to 5 carbon atoms, a carbonyl group, a sulfonyl group, a fluoroalkylene group having 1 to 6 carbon atoms, or a divalent group having 2 to 6 carbon atoms in which alkylene units or fluoroalkylene units are bonded via ether group.

In formula (C), R₁ and R₂ are each independently preferably a hydrogen atom, an alkyl group having 1 to 3 carbon atoms or a halogen group, and R₃ is more preferably an alkylene group or fluoroalkylene group having 1 or 2 carbon atoms.

Preferable examples of the cyclic disulfonic acid esters represented by the formula (C) include compounds represented by the following formulae (1) to (20).

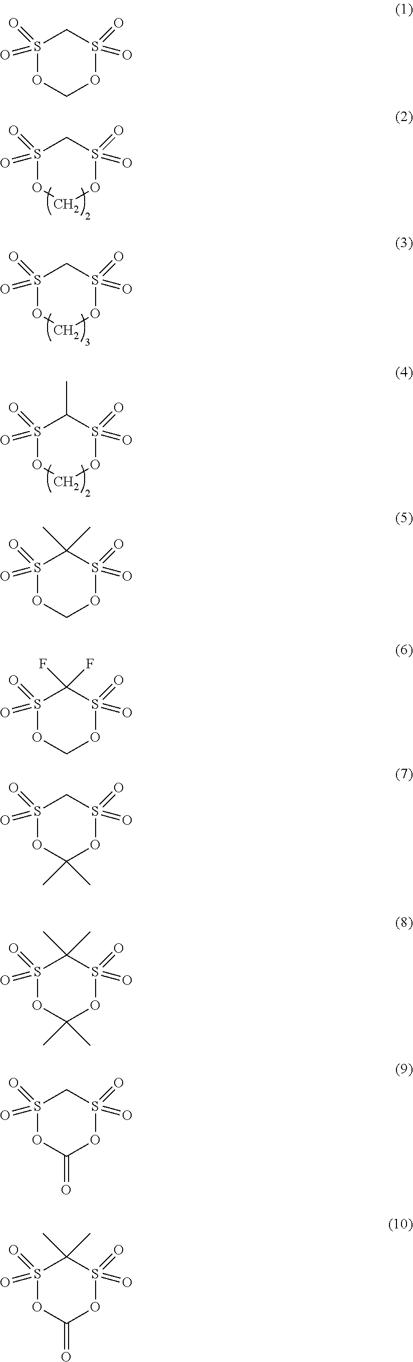

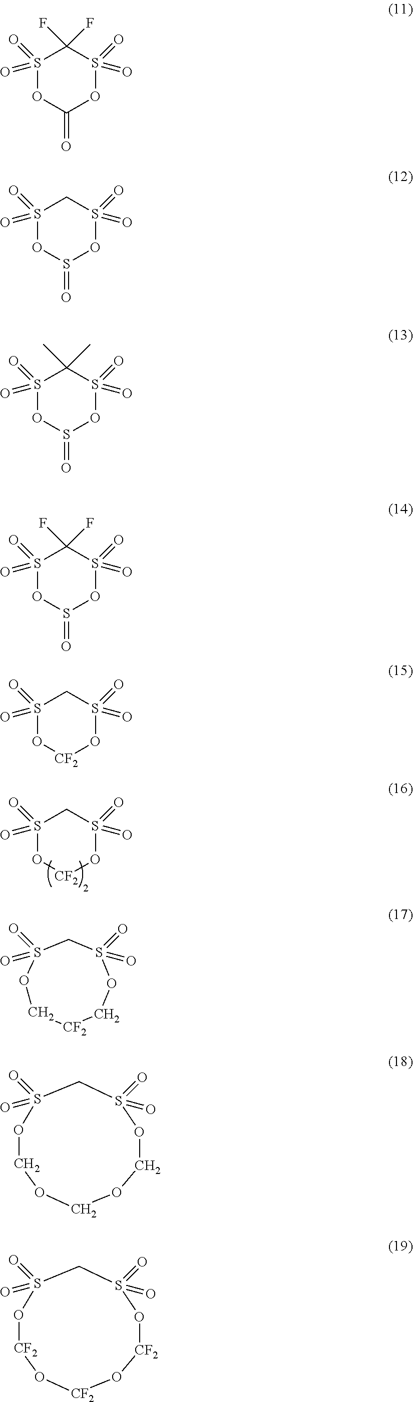

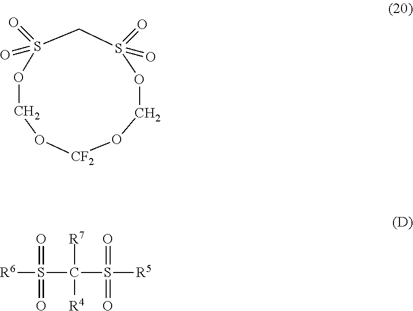

In formula (D), R⁴ and R⁷ each independently represent an atom or a group selected from the group consisting of a hydrogen atom, an alkyl group having 1 to 5 carbon atoms, an alkoxy group having 1 to 5 carbon atoms, an fluoroalkyl group having 1 to 5 carbon atoms, an polyfluoroalkyl group having 1 to 5 carbon atoms, —SO₂X₃ (X₃ is an alkyl group having 1 to 5 carbon atoms), —SY₁ (Y₁ is an alkyl group having 1 to 5 carbon atoms), —COZ (Z is a hydrogen atom or an alkyl group having 1 to 5 carbon atoms), and a halogen atom. R⁵ and R⁶ each independently represent an atom or a group selected from an alkyl group having 1 to 5 carbon atoms, an alkoxy group having 1 to 5 carbon atoms, a phenoxy group, a fluoroalkyl group having 1 to 5 carbon atoms, a polyfluoroalkyl group having 1 to 5 carbon atoms, a fluoroalkoxy group having 1 to 5 carbon atoms, a polyfluoroalkoxy group having 1 to 5 carbon atoms, a hydroxyl group, a halogen atom, —NX₄X₅ (X₄ and X₅ are each independently a hydrogen or an alkyl group having 1 to 5 carbon atoms) and —NY₂CONY₃Y₄ (Y₂ to Y₄ are each independently a hydrogen atom or an alkyl group having 1 to 5 carbon atoms).

In the formula (D), R⁴ and R⁷ are, independently each other, preferably a hydrogen atom, an alkyl group having 1 or 2 carbon atoms, a fluoroalkyl group having 1 or 2 carbon atoms, or a halogen atom, and R⁵ and R⁶, independently each other, represent preferably an alkyl group having 1 to 3 carbon atoms, an alkoxy group having 1 to 3 carbon atoms, a fluoroalkyl group having 1 to 3 carbon atoms, a polyfluoroalkyl group having 1 to 3 carbon atoms, a hydroxyl group or a halogen atom.

Preferred compounds of the open-chain disulfonic acid ester compound represented by the formula (D) include, for example, the following compounds.

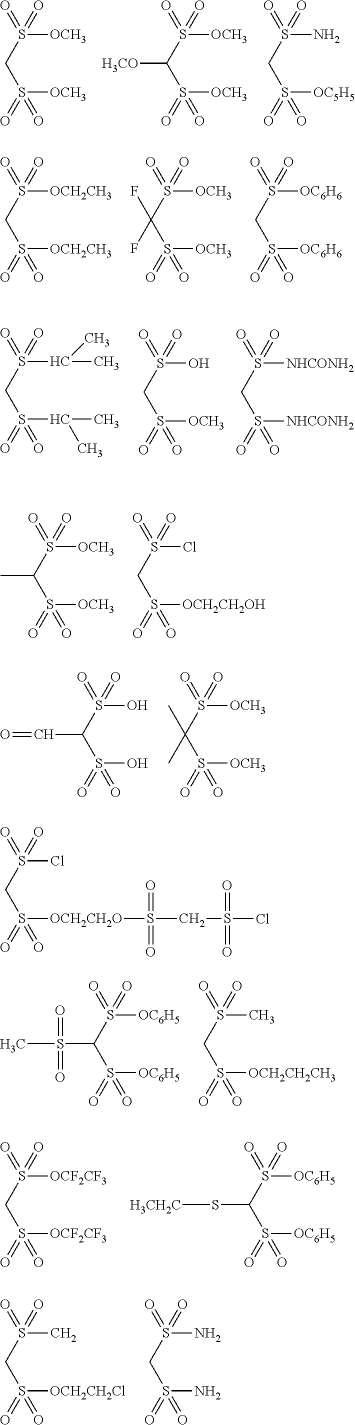

The content of the cyclic or open-chain disulfonic acid ester in the electrolyte solution is preferably 0.01% by mass or more and 10% by mass or less. When the content is 0.01% by mass or more, a sufficient film effect can be obtained. When the content is 10% by mass or less, an increase in the viscosity of the electrolyte solution and an increase in resistance associated therewith can be suppressed.

### [Separator]

The separator may be of any type as long as it suppresses electric conduction between the positive electrode and the negative electrode, does not inhibit the permeation of charged substances, and has durability against the electrolyte solution. Specific examples of the material include polyolefins such as polypropylene and polyethylene; cellulose, polyethylene terephthalate, polyimide, polyvinylidene fluoride; and aromatic polyamides (aramid) such as polymetaphenylene isophthalamide, polyparaphenylene terephthalamide and copolyparaphenylene-3,4′-oxydiphenylene terephthalamide; and the like. These can be used as porous films, woven fabrics, nonwoven fabrics and the like.

### [Insulation Layer]

An insulation layer may be formed on at least one surface of the positive electrode, the negative electrode and the separator. Examples of a method for forming the insulation layer include a doctor blade method, a dip coating method, a die coater method, a CVD method, a sputtering method and the like. An insulation layer may be formed at the same time as forming the positive electrode, the negative electrode, or the separator. Examples of materials constituting the insulation layer include a mixture of aluminum oxide, barium titanate or the like and SBR or PVDF.

### [Structure of Lithium Ion Secondary Battery]

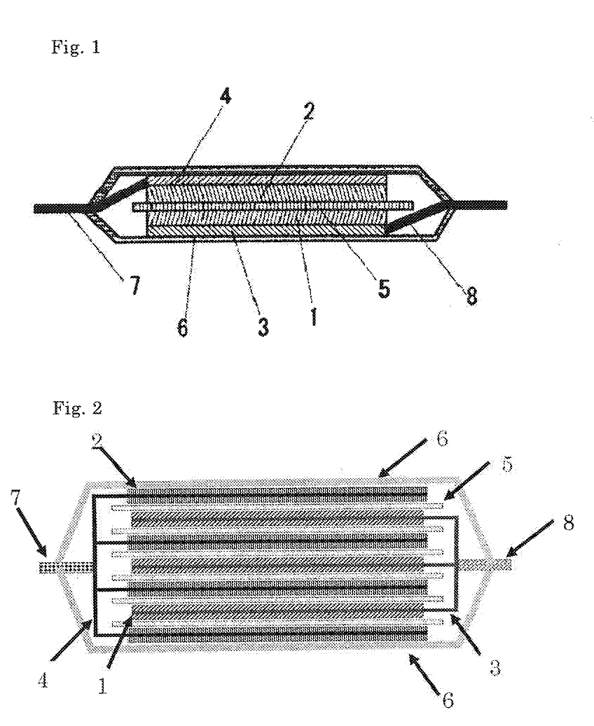

FIG. 1 shows a laminate-type secondary battery as an example of a secondary battery according to the present embodiment. The separator 5 is sandwiched between a positive electrode comprising a positive electrode active material layer 1 containing a positive electrode active material and a positive electrode current collector 3 and a negative electrode comprising a negative electrode active material layer 2 and a negative electrode current collector 4. The positive electrode current collector 3 is connected to the positive electrode lead terminal 8 and the negative electrode current collector 4 is connected to the negative electrode lead terminal 7. The exterior laminate 6 is used for the outer package, and the interior of the secondary battery is filled with an electrolyte solution. The electrode element (also referred to as “battery element” or “electrode laminate”) preferably has a structure in which a plurality of positive electrodes and a plurality of negative electrodes are stacked via separators, as shown in FIG. 2.

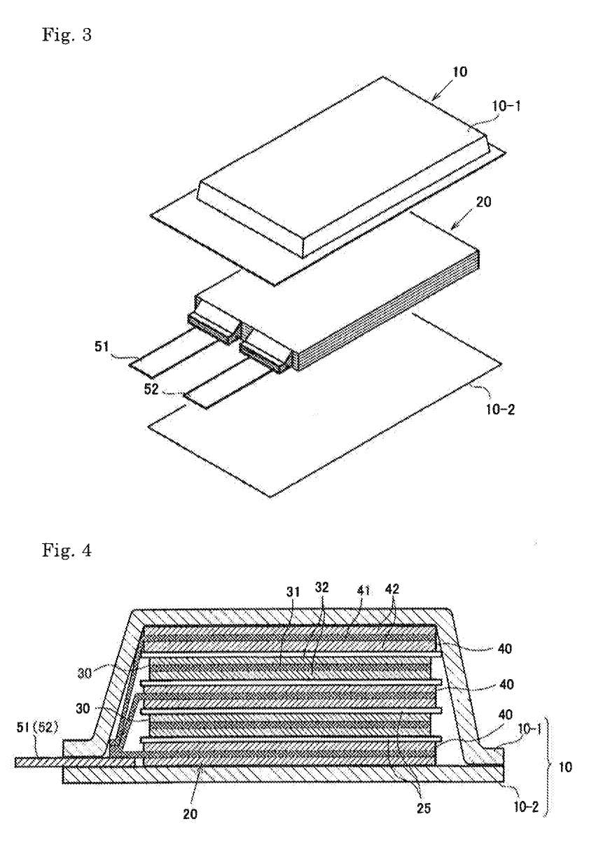

As another embodiment, a secondary battery having a structure as shown in FIG. 3 and FIG. 4 may be provided. This secondary battery comprises a battery element 20, a film package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 4. In the positive electrode 30, an electrode material 32 is applied to both surfaces of a metal foil 31, and also in the negative electrode 40, an electrode material 42 is applied to both surfaces of a metal foil 41 in the same manner. The present invention is not necessarily limited to stacking type batteries and may also be applied to batteries such as a winding type.

In the secondary battery in FIG. 1, the electrode tabs are drawn out on both sides of the package, but a secondary battery to which the present invention may be applied may have an arrangement in which the electrode tabs are drawn out on one side of the package as shown in FIG. 3. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 4). The portion in which the extended portions are brought together into one in the stacking direction in this manner is also referred to as a “current collecting portion” or the like.

The film package 10 is composed of two films 10-1 and 10-2 in this example. The films 10-1 and 10-2 are heat-sealed to each other in the peripheral portion of the battery element 20 and hermetically sealed. In FIG. 3, the positive electrode tab 51 and the negative electrode tab 52 are drawn out in the same direction from one short side of the film package 10 hermetically sealed in this manner.

Of course, the electrode tabs may be drawn out from different two sides respectively. In addition, regarding the arrangement of the films, in FIG. 3 and FIG. 4, an example in which a cup portion is formed in one film 10-1 and a cup portion is not formed in the other film 10-2 is shown, but other than this, an arrangement in which cup portions are formed in both films (not illustrated), an arrangement in which a cup portion is not formed in either film (not illustrated), and the like may also be adopted.

### [Method for Manufacturing Lithium Ion Secondary Battery]

The lithium ion secondary battery according to the present embodiment can be manufactured according to a conventional method. An example of a method for manufacturing a lithium ion secondary battery will be described taking a stacked laminate type lithium ion secondary battery as an example. First, in the dry air or an inert atmosphere, the positive electrode and the negative electrode are placed to oppose to each other via a separator to form the electrode element. Next, this electrode element is accommodated in an outer package (container), an electrolyte solution is injected, and the electrode is impregnated with the electrolyte solution. Thereafter, the opening of the outer package is sealed to complete the lithium ion secondary battery.

### [Assembled Battery]

A plurality of lithium ion secondary batteries according to the present embodiment may be combined to form an assembled battery. The assembled battery may be configured by connecting two or more lithium ion secondary batteries according to the present embodiment in series or in parallel or in combination of both. The connection in series and/or parallel makes it possible to adjust the capacitance and voltage freely. The number of lithium ion secondary batteries included in the assembled battery can be set appropriately according to the battery capacity and output.

### [Vehicle]

The lithium ion secondary battery or the assembled battery according to the present embodiment can be used in vehicles. Examples of the vehicle according to an embodiment of the present invention include hybrid vehicles, fuel cell vehicles, electric vehicles (besides four-wheel vehicles (cars, trucks, commercial vehicles such as buses, light automobiles, etc.), two-wheeled vehicle (bike) and tricycle), and the like. The vehicles according to the present embodiment is not limited to automobiles, it may be a variety of power source of other vehicles, such as a moving body like a train.

### EXAMPLES

Hereinafter, an embodiment of the present invention will be explained in details with reference to examples, but the present invention is not limited to these examples.

### Example 1

Preparation of the battery of the present examples will be described.

### (Positive Electrode)

A lithium nickel composite oxide (LiNi_{0.80}Co_{0.15}Al_{0.05}O₂) as a positive electrode active material, carbon black as a conductive assistant agent and polyvinylidene fluoride as a binder were weighed so that a mass ratio was 90:5:5 and they were kneaded using N-methylpyrrolidone to prepare a positive electrode slurry. The prepared positive electrode slurry was applied to one surface of aluminum foil having a thickness of 20 μm as a current collector and dried, and further pressed to prepare a positive electrode.

### (Negative Electrode)

As the negative electrode active material, graphite and an alloy of Si and Ti (wherein Ti content is 1 wt %, and hereinafter also referred to as “Si alloy”) were used. The 50% particle diameter of the alloy of Si and Ti was 0.5 μm. The specific surface area (CS) of the alloy of Si and Ti was 15 m²/cm³. The mixing ratio between graphite and the alloy of Si and Ti was 74:26 by mass ratio. This negative electrode active material, acetylene black as a conductive assistant agent, and a binder formed of a polymer (polyacrylic acid) prepared from unsaturated carboxylic acid-based monomer, unsaturated carboxylic acid sodium monomer, conjugated diene-based monomer and ethylenically unsaturated carboxylic acid ester as a negative electrode binder, were weighed so that a mass ratio was 96:1:3. Then, these were mixed with water to prepare a negative electrode slurry. The negative electrode slurry was applied to a copper foil having a thickness of 10 μm, dried, and further heat-treated at 100° C. under vacuum to prepare a negative electrode.

### (Separator)

As a separator, a PP aramid composite separator in which a microporous film made of PP (polypropylene) having a thickness of 20 μm and an aramid non-woven fabric film having a thickness of 20 μm were laminated and subjected to heat roll pressing at 130° C. was used.

### (Electrode Laminate)

The three positive electrode layers and the four negative electrode layers thus prepared were alternately stacked with a separator interposed therebetween. End portions of the positive electrode current collector which was not covered with a positive electrode active material and the negative electrode current collector which was not covered with a negative electrode active material were respectively welded. Then, a positive electrode terminal made of aluminum and a negative electrode terminal made of nickel were attached by welding to the respective welded portions to obtain an electrode stacked body having a planar laminated structure.

### (Electrolyte Solution)

In a mixed solvent of EC (ethylene carbonate) and DEC (diethyl carbonate) (volume ratio: EC/DEC=30/70) as a non-aqueous solvent, LiFSI and LiPF₆ as supporting salts were added so as to be 14 weight % and 8 wt % in the electrolyte solution, respectively. Further, as a first additive, FEC (fluoroethylene carbonate) was added so as to be 10 wt % in the electrolyte solution to prepare a non-aqueous electrolytic solution.

### (Production of Battery)

The above electrode laminate was wrapped with aluminum laminate film as an outer package and the electrolyte solution was injected within the outer package, and then the outer package was sealed while the pressure was being reduced to 0.1 atm, thereby producing a secondary battery.

### (Evaluation)

For the produced secondary battery, charge and discharge were repeated 150 times within a voltage range from 2.5 V to 4.2 V in a thermostatic chamber kept at 45° C., and the capacity retention ratio was evaluated. Charging was performed at 1 C up to 4.2 V and then constant voltage charging was performed for a total of 2.5 hours. Discharging was performed at a constant current at 1 C down to 2.5 V. “Capacity retention ratio (%)” was calculated by {(discharge capacity after 150 cycles)/(discharge capacity after 1 cycle)}×100 (unit: %). The results are shown in Table 1.

### Examples 2-6, Comparative Examples 1-8

Lithium ion secondary batteries were produced and the capacity retention ratios thereof were evaluated in the same manner as in Example 1 except that the content of the silicon alloy in the negative electrode active material and the contents of LiPF₆, LiFSI and FEC in the electrolyte solution were changed as shown in Table 1, and in Examples 4 to 6 and Comparative Example 8, a second additive shown in Table 1 was further added to the electrolyte solution. The results are shown in Table 1.

TABLE 1

| | Negative | | | | | | |
|---|---|---|---|---|---|---|---|
| | electrode active | | | | | | |
| | material | | | | | | |
| | Ratio of | Electrolyte solution | | | | | |
| | Si alloy | | | First | | | Capacity |
| | in negative | | | additive | | | retention |
| | electrode active | LiPF₆ | LiFSI | (FEC) | Second | concentration | ratio after |
| | material | concentration | concentration | concentration | additive | of X | 150 cycles |
| | wt % | wt % | wt % | wt % | X | wt % | % |
| Example 1 | 26 | 8 | 14 | 10 | — | | 69.3 |
| Example 2 | 30 | 8 | 14 | 10 | — | | 68.6 |
| Example 3 | 35 | 8 | 14 | 10 | — | | 66.5 |
| Example 4 | 35 | 8 | 14 | 10 | MMDS | 1 | 69.8 |
| Example 5 | 35 | 8 | 14 | 10 | MA | 1 | 70.1 |
| Example 6 | 35 | 8 | 14 | 10 | FGA | 1 | 69.5 |
| Comparative | 25 | 15 | 14 | 10 | — | | 56 |
| Example 1 | | | | | | | |
| Comparative | 26 | 8 | 14 | 0 | — | | <20 |
| Example 2 | | | | | | | |
| Comparative | 26 | 8 | 14 | 5 | — | | <20 |
| Example 3 | | | | | | | |
| Comparative | 26 | 5 | 5 | 10 | — | | <20 |
| Example 4 | | | | | | | |
| Comparative | 10 | 15 | 14 | 10 | — | | 75.6 |
| Exainple 5 | | | | | | | |
| Comparative | 20 | 15 | 14 | 10 | — | | 73.5 |
| Example 6 | | | | | | | |
| Comparative | 35 | 8 | 14 | 0 | — | | <20 |
| Example 7 | | | | | | | |
| Comparati've | 35 | 8 | 14 | 0 | MMDS | 1 | <20 |
| Example 8 | | | | | | | |

LiFSI: LiN(SO₂F)₂
MMDS: Methylene methane disulfonic acid ester
MA: Maleic anhydride
FGA: Hexafluoroglutaric anhydride
“<20” denotes that the capacity retention ratio could not be measured due to severe deterioration during charge and discharge.

Examples 1 to 6 were superior to Comparative Examples 1 to 4, 7 and 8 in capacity retention ratio after 150 cycles. In Comparative Example 1, since the concentration of LiPF₆ was high, the capacity retention ratio was lower than that in Examples. This is because LiPF₆ in the electrolyte solution mainly reacts with the Si alloy to be denatured and become an insulating material, which does not contribute to charge and discharge. In Comparative Examples 2, 3, 7 and 8, since the concentrations of FEC were low, the capacity retention ratios were lower than those in Examples. This is because FEC was consumed during the cycle and the concentration of FEC became zero, and thus the Si alloy reacted with LiPF₆ in the electrolyte solution to become an insulating material and no longer contributed to charge and discharge. In Comparative Example 4, since the concentration of LiFSI was low, the capacity retention ratio was lower than that in Examples. This is because when the electrical conductivity of the electrolyte solution decreases during the cycle due to the low concentration of LiFSI, sufficient electrical conductivity for evaluating the cycle characteristics cannot be obtained. In Comparative Examples 5 and 6, since the contents of the Si alloy in the negative electrode active material are small, the negative electrode capacities are small and the energy densities of the secondary batteries are low as compared with Examples.

This application is based upon and claims the benefit of priority from Japanese Patent Application No. 2016-105374 filed on May 26, 2016, the disclosures of which are incorporated herein in their entirety by reference.

While the invention has been shown and described with reference to embodiments and examples, the invention is not limited to these embodiments and examples. It will be understood by those of ordinary skill in the art that various changes in form and details may be made therein without departing from the scope of the present invention as defined by the claims.

### INDUSTRIAL APPLICABILITY

The lithium ion secondary battery according to the present invention can be used, for example, in all industrial fields requiring power supply, and industrial fields related to transportation, storage and supply of electrical energy. Specifically, it can be utilized for, for example, an electric power source of a mobile device such as a mobile phone and a notebook computer; an electric power source of a moving or transport medium including an electric vehicle such as an electric car, a hybrid car, an electric motorcycle and an electric power-assisted bicycle, a train, a satellite and a submarine; a back-up electric power source such as UPS; and an electric power storage device for storing an electric power generated by solar power generation, wind power generation, and the like.

### EXPLANATION OF REFERENCE

1 positive electrode active material layer
2 negative electrode active material layer
3 positive electrode current collector
4 negative electrode current collector
5 separator
6 exterior laminate
7 negative electrode lead terminal
8 positive electrode lead terminal
10 film outer package
20 battery element
25 separator
30 positive electrode
40 negative electrode

1. A lithium ion secondary battery comprising:
a negative electrode comprising a negative electrode active material comprising a silicon alloy and
a non-aqueous electrolyte solution comprising a compound represented by LiN(SO₂CₙF₂ₙ₊₁)₂ (wherein n is an integer of 0 or more) and fluoroethylene carbonate (FEC), wherein
a content of the silicon alloy in the negative electrode active material is more than 25% by weight, and
a content of the compound represented by LiN(SO₂CₙF₂ₙ₊₁)₂ (wherein n is an integer of 0 or more) is more than 10% by weight, a content of FEC is 10% by weight or more, and a content of LiPF₆ is 10% by weight or less, in the non-aqueous electrolyte solution.

2. The lithium ion secondary battery according to claim 1, wherein the compound represented by LiN(SO₂CₙF₂ₙ₊₁)₂ (wherein n is an integer of 0 or more) comprises lithium bis(fluorosulfonyl)imide.

3. The lithium ion secondary battery according to claim 1, wherein the non-aqueous electrolyte solution comprises at least one compound selected from the group consisting of an unsaturated carboxylic acid anhydride, a fluorinated carboxylic acid anhydride, an unsaturated cyclic carbonate, a cyclic disulfonic acid ester and an open-chain disulfonic acid ester.

4. The lithium ion secondary battery according to claim 1, wherein the non-aqueous electrolyte solution comprises LiPF₆ in an amount of 0.1 to 10% by weight.

5. The lithium ion secondary battery according to claim 1, wherein the negative electrode comprises polyacrylic acid.

6. The lithium ion secondary battery according to claim 5, wherein the polyacrylic acid comprises a monomer unit based on an ethylenically unsaturated carboxylic acid, and a monomer unit based on an alkali metal salt of an ethylenically unsaturated carboxylic acid and/or a monomer unit based on an aromatic vinyl compound.

7. A vehicle equipped with the lithium ion secondary battery according to claim 1.
